(19) United States
(12) Patent Application Publication
(10) Pub. No.: US 2010/0173043 A1
(43) Pub. Date: Jul. 8, 2010

(54) USE OF TANNINS IN ENOLOGY

(75) Inventors: Bruno Marquette, Saint Caprais de Bordeaux (FR); Jean-Francois Laffort, Bordeaux (FR)

Correspondence Address: YOUNG & THOMPSON, 209 Madison Street, Suite 500, Alexandria, VA, 22314, US

(73) Assignee: STELLARARTS COPORATION, OKAYA-SHI (JP)

(21) Appl. No.: 12/666,043

(22) PCT Filed: Jun. 17, 2008
(86) PCT No.: PCT/FR08/51077

§ 371 Date: Dec. 22, 2009

(30) Foreign Application Priority Data
Jun. 9, 2007 (FR) 07 55857

(51) Int. Cl. C12G 1/02; A01N 43/16; A01P 1/00; C12H 1/14

(52) U.S. Cl. 426/12; 514/456; 426/592

(57) ABSTRACT

The subject of the invention is the use, as an oenological product, of a proanthocyanidin tannin of phloroglucinol type that does not contain or contains very few ferulic and paracoumaric acids.

This invention relates to the utilization of special tannins for use in enology.

The tannins are phenolic compounds that are present in most vegetables. Some of them have been known for centuries and are used in numerous fields.

In particular, the tannins find various applications in enology. They are used, for example, to clarify wine, to absorb undesirable components, to stabilize the coloring material, or else to improve the structure of the wines.

The tannins that are used in enology belong to two families: hydrolyzable tannins and condensed tannins.

Among the hydrolyzable tannins, ellagic tannins, which have essentially oak and Spanish chestnut for their plant origin, and gallic tannins, which can come from different types of wood, fruits, or even a hypertrophy of vegetable fabrics such as the gall nut, are commonly used.

As for the condensed tannins, they are used particularly in enology to stabilize the coloring material of wines over time.

This stability is to be ensured by two phenomena: the polymerization of tannins, i.e., the combination of tannins with one another, and the condensation of tannins with grape anthocyanins. This reaction is important for the aging of wines because an anthocyanin in free form is sensitive to temperature, to light and to oxidation, which can bring about its degradation and consequently a reduction in the color of the wines.

It is known that the tannins that are obtained from grapes are extremely effective for stabilizing the coloring material of wines but are sometimes present in the natural state in inadequate proportions relative to the anthocyanins in must or wine. It then is necessary to compensate for this deficiency in nature by adding exogenic condensed tannins.

Nevertheless, despite their qualities, the grape tannins are not used very much because they are very expensive. In addition, they contain phenol acids, in particular paracoumaric and ferulic acids, which form undesirable phenolated derivatives in the wine that are responsible for an organoleptic degradation, in particular olfactory defects.

This is why substitutes for grape tannin have been sought.

Currently, the only known substitutes for grape tannin that are used in enology are resorcinol-type proanthocyanidic tannins that are extracted from Quebracho and Mimosa, corresponding to the following formula:

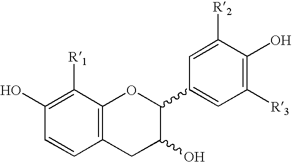

However, these tannins are not satisfactory for correctly stabilizing the coloring material of wines.

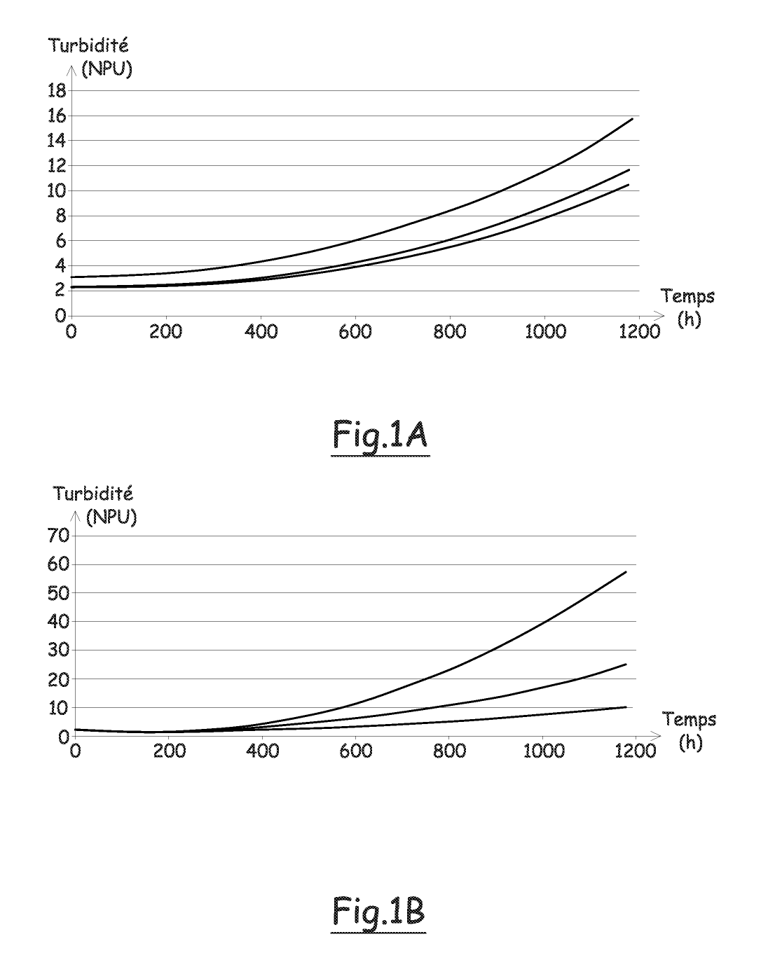

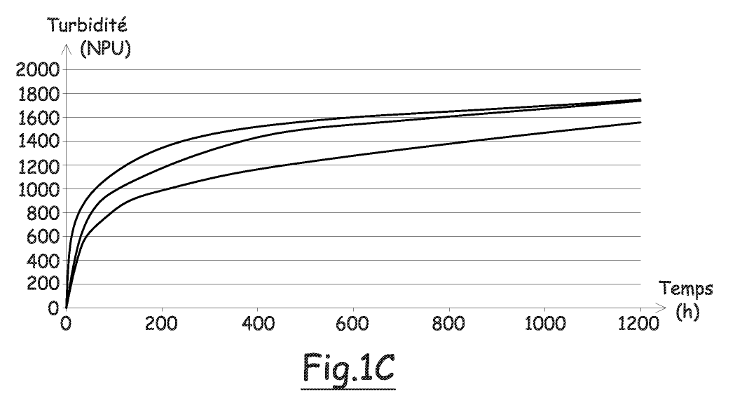

In FIGS. 1a to 1c, the effectiveness of these tannins is compared to that of the grape tannins, for stabilizing the coloring materials of wines, by studying the kinetics of combinations between the tannins by means of acetaldehyde or ethanol. Actually, the ability of tannins to become polymerized can be evaluated by the measurement of the cloudiness formed over time after acetaldehyde is added to a tannin solution. The appearance of cloudiness in a hydroalcoholic solution is measured until a maximum is Obtained. The more quickly the cloudiness that is formed grows, the more effective the tannin is for the desired effect.

The tannins are tested at a concentration of 3 g/L for two different volumes of acetaldehyde (200 and 400 μl). Three measurements have been made for each sample With a nephelometer in tanks that are 0.9 mm in diameter.

The results that are obtained show that the Mimosa tannins (FIG. 1a) and the Quebracho tannins (FIG. 1b) form very little or no cloudiness, whereas the grape tannins (FIG. 1c) react and quickly precipitate.

Also, the purpose of this invention is to overcome the drawbacks of the prior art by proposing to use tannins that have good enological qualities, in particular for stabilizing the coloring material of wines, while not exhibiting the drawbacks of the grape tannin.

For this purpose, the invention has as its object the use as enological product of at least one phloroglucinol-type proanthocyanidic tannin that contains less than 10 ppm (parts per million) of para-coumaric acid-type and/or ferulic acid-type phenol acids.

This tannin can be used on a grape must, a must that is still in fermentation, or a wine so as to stabilize the coloring material. It can also be used to improve the structure of a wine to facilitate the clarification of a wine in synergy with a clarifier, to absorb undesirable protein components of wine, for an antibacterial action, and/or for an antioxidant action in a wine.

The invention is now described in detail with regard to nonlimiting examples, tests, and accompanying drawings in which:

FIG. 1 shows the changes in cloudiness formed between Mimosa tannins and acetaldehyde over time,

FIG. 1b shows the changes in cloudiness formed between Quebracho tannins and acetaldehyde over time,

FIG. 1c shows the changes in cloudiness formed between grape tannins and acetaldehyde over time,

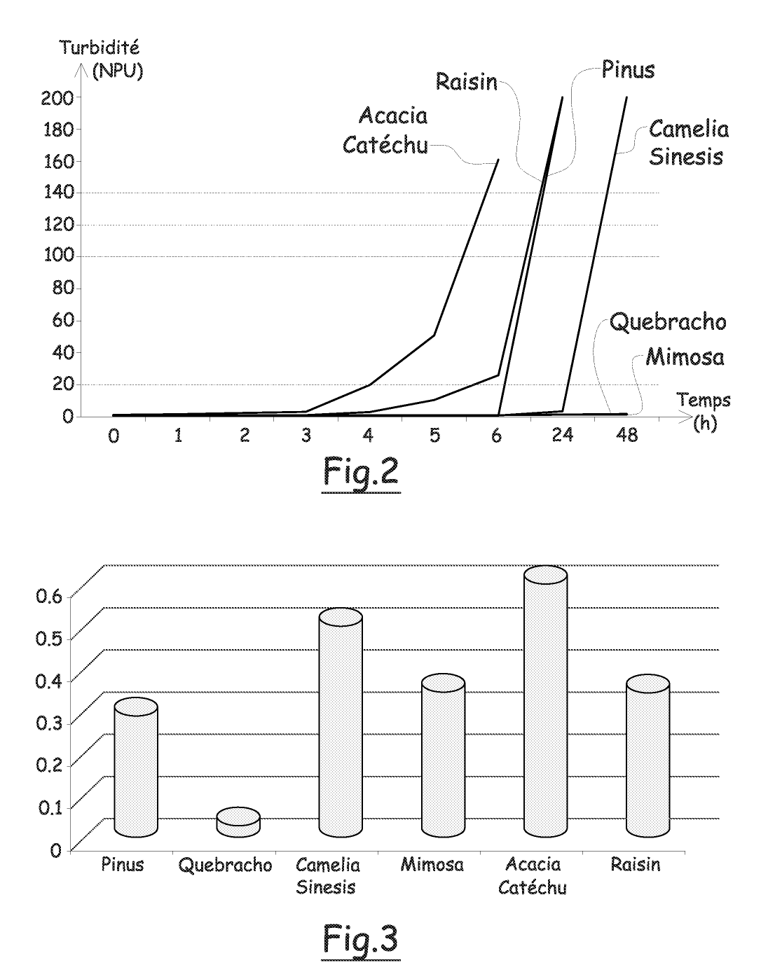

FIG. 2 shows the action of ethanal on the turbidity of tannin solutions at pH 3.3 over time,

FIG. 3 shows the metering by optical density DO 640, catechins, epicatechins, and their derivatives that are present in tannins by the reaction with 4-dimethylaminocinnamaldehyde,

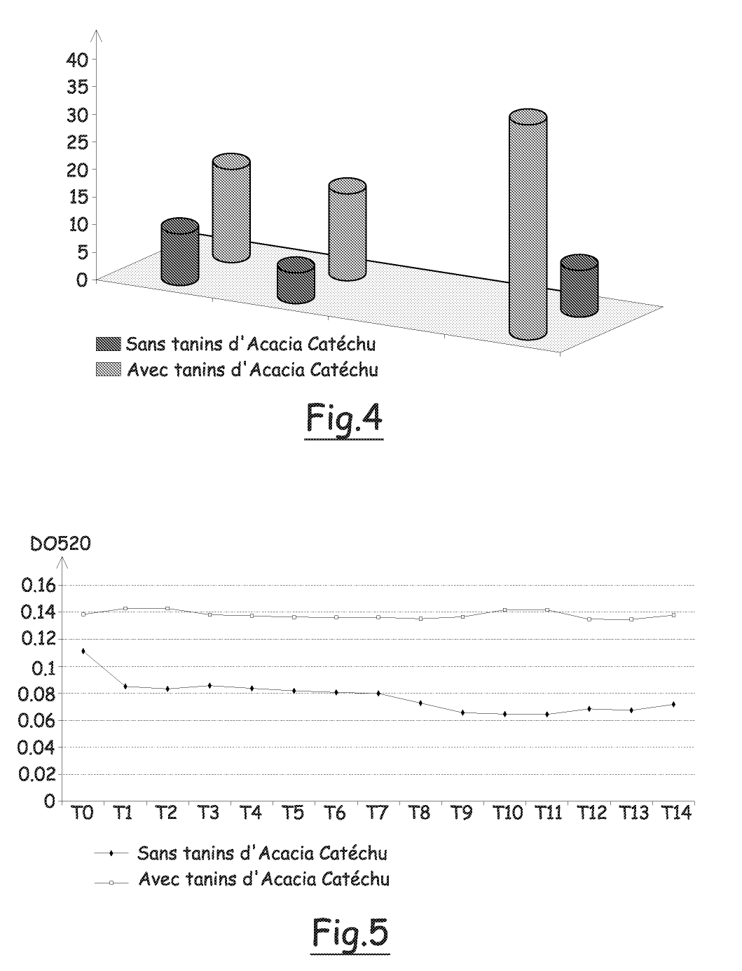

FIG. 4 shows the changes in the red color of a substituted solution of wine when sulfurous anhydride is added in the presence and in the absence of Acacia catechu tannins, and

FIG. 5 shows the measurement of the turbidity of anthocyanin solutions in a double-boiler at 80° C., in the presence and in the absence of Acacia catechu tannins.

The purpose of this invention is the utilization for use in enology of phloroglucinol-type proanthocyanidic tannins whose monomers correspond to the following formula (I):

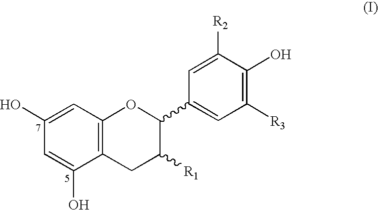

in which R1, R2, and R3 independently represent either a hydrogen (—H) or a hydroxyl group (—OH).

The useful tannins according to the invention contain between 0 and 10 ppm of paracoumaric acid-type and/or ferulic acid-type phenol acids.

Preferably, the useful tannins according to the invention are procyanidines or prodelphinidines.

Even more preferably, the useful tannins according to the invention are rich in monomers/units of formula (I) with R1=R2=OH and R3=H.

In particular, useful tannins according to the invention are tannins that are rich in (+)catechin monomers and/or its isomeric (−)epicatechin form and/or the derivatives thereof, shown by the following formula II:

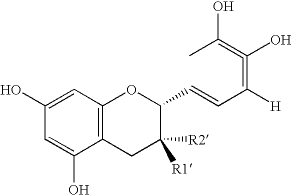

in which

R1′=OH and R2′=H for the (+)catechin and its derivatives, and

R1′=H and R2′=OH for the (−)epicatechin and its derivatives.

Preferably, the useful tannins according to the invention are Acacia catechu extracts that belong to Fabaceae, Camelia sinensis leaves that belong to Ternstroemiaceae, or else pine bark that belongs to Pinaceae, more particularly Pinus sylvestris or Pinus pinaster.

According to a particularly suitable variant, a useful tannin according to the invention is a tannin that comprises at least 30% (+)catechin units and/or its derivatives relative to the total of (+)catechin and (−)epicatechin units and their derivatives that constitute said tannin, such as a tannin that is extracted from Acacia catechu or pine bark.

Preferably, it is a tannin that comprises at least 50% (+)catechin and/or its derivatives relative to the total of (+)catechin, (−)epicatechin, and their derivatives that Constitute said tannin, even more preferably at least 70%. The extraction of tannins can be done by the means that are conventionally used in the field, either with water or by solvents such as alcohol or ether, or by enzymatic systems.

Advantageously, the tannins according to the invention have good capacities for interaction and combination with the anthocyanins of wine. They are particularly effective for stabilizing the coloring material of wines.

Actually, during wine-making, in particular during the wine-making in casks, a small amount of ethanol oxidizes into acetaldehyde (or ethanal).

This ethanal can react with monomers of catechinic- or epicatechinic-type tannins, or their useful derivatives according to the invention, to form an ethanal bridge and to fix the anthocyanins. The anthocyanins that are fixed by this combination are much more resistant to degradation, which makes it possible to stabilize the color of the wines.

It is the positioning of the hydroxyl groups in positions 5 and 7 on the monomers of the tannins that makes these molecules extremely reactive in the presence of ethanal to produce the ethanol bridge and to fix anthocyanins. Actually, this configuration of useful molecules according to the invention, different from that of the Quebracho and Mimosa tannins, makes possible the outsourcing of negative charges, as shown in the diagram below, and consequently the combination of the molecule with the ethanal that, in an acidic medium like the must or the wine, forms a positively-charged carbocation.

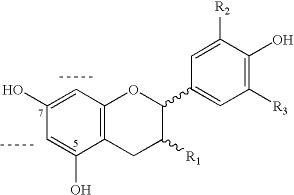

The condensation reaction of the tannins according to the invention with the grape anthocyanins can be illustrated by an example of condensation between a tannin whose basic molecule is catechin and an anthocyanin, the malvidine-3-monoglucoside, which is carried out according to the following reaction diagram:

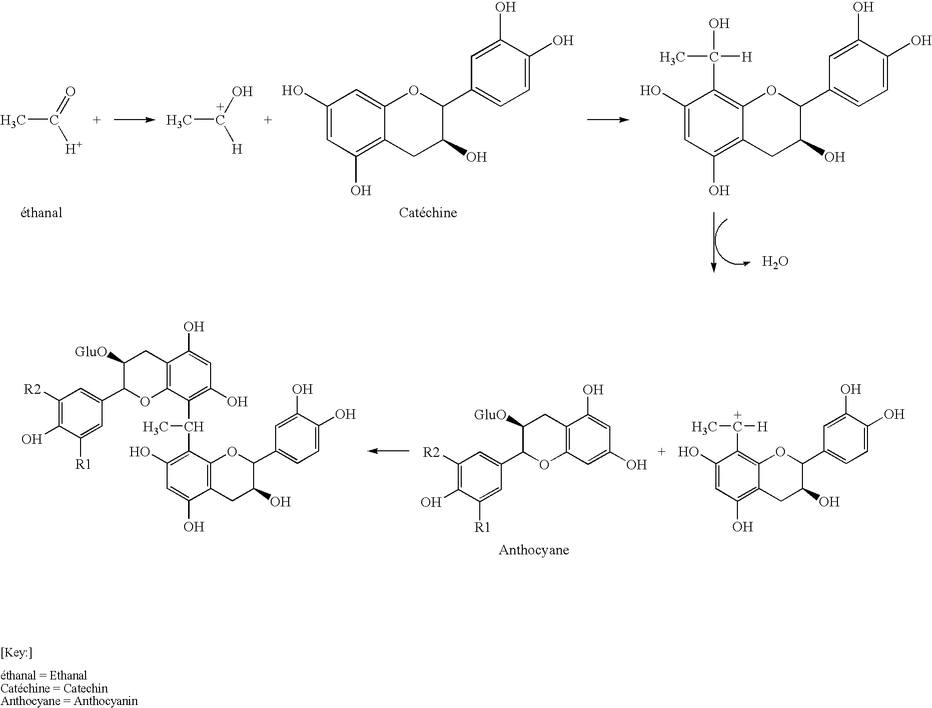

This same reaction can be carried out, of course, with the isomeric (−)epicatechin form and its derivatives.

According to another aspect, the ethanal that is released during the wine-making also makes possible the formation of tannin polymers that are linked to one another via C4-C6 or C4-C8 ethyl bridges. These polymers quickly become insoluble and precipitate beyond a certain size.

Tests have been carried out to show the effectiveness of three examples of useful tannins according to the invention and to compare then to tannins that are currently used.

Experiments by nephelometry have been carried out for studying the kinetics of combinations between the tannins according to the invention by means of ethanal.

The ability of the tannins to become polymerized was evaluated by measuring the cloudiness that is formed over time after acetaldehyde is added to a tannin solution. The appearance of cloudiness in a hydroalcoholic solution is measured until a maximum is obtained, which makes it possible to specify the reactivity of the molecules to one another in the presence of ethanal and to specify their ability to form pigments that are polymerized with the anthocyanins of wine.

The operating procedure is as follows:

The tannins are extracted with water at a specified temperature, and then are next filtered and concentrated before being dried by atomization.

They are incorporated in a hydroalcoholic solution at a rate of a concentration of 3 g/L.

The volume of tested acetaldehyde is 500 μl.

At each time T, three measurements are made for each sample using a nephelometer in tanks with a diameter of 0.9 mm.

The useful tested tannins according to the invention are tannins that are extracted from Acacia catechu, Camelia sinensis leaves, and pine bark.

In parallel, Quebracho and Mimosa extracts, as well as grape tannins, have also been tested.

The results that are obtained over 72 hours are presented in FIG. 2. It is noted that the Acacia catechu tannin has an excellent reactivity and becomes polymerized under the action of ethanal even more quickly than the grape tannin.

The pine bark tannin and the Camelia sinensis tannin also become polymerized quickly in the presence of ethanal and saturate the turbidimeter respectively at the end of 6 hours and 24 hours.

In contrast, it is noted that the Quebracho and Mimosa tannins have virtually not changed even after 72 hours of reaction.

The results that are obtained also show a difference in reactivity between the Acacia catechu tannins and pine bark, on the one hand, and the Camellia sinensis tannin on the other, which is explained by the fact that the Acacia catechu tannin and that of pine bark are very rich in (+)catechin units and derivatives thereof, whereas the Camellia sinensis tannin essentially contains the (−)epicatechin form and its derivatives, a much less reactive form than the (+)catechin.

This is why a preferred variant of this invention resides in the use of tannins comprising at least 30% (+)catechin and/or its derivatives relative to the total of (+)catechin, (−)epicatechin and derivatives thereof, such as tannins that are extracted from Acacia catechu or pine bark.

FIG. 3 illustrates the metering of catechin and epicatechin in tannins that are obtained from Acacia catechu, Camelia sinensis and pine, in comparison to the metering of catechin and epicatechin in grape tannins, and Quebracho and Mimosa tannins.

The tannins have been extracted with water at a specified temperature, and then filtered and concentrated before being dried by atomization. They have been incorporated into aqueous solutions at a rate of 100 mg/l, diluted to 1/4, and the metering of the catechins and epicatechins is carried out by the reaction with 4-dimethylaminocinnamaldehyde. The results are provided in optical density OD 640.

It is noted that the tannins that are obtained from Acacia catechu, Camelia sinensis and Pinaceae are rich in catechin and epicatechin, like the grape tannin. By contrast, the Quebracho and Mimosa tannins contain only very little tannin that has catechin and epicatechin for a base, which explains in particular their absence of interaction with ethanal.

Furthermore, the capacities for interaction and stabilizing action of the tannins that are obtained from Acacia catechu have also been tested.

The experimentation was done on a model solution that consists of anthocyanins metered at 2 g/l in a conventional synthetic medium that reflects the medium of the wine. This medium was supplemented with ethanal, in a relatively low concentration, 0.01%, so that the tannins can be combined with anthocyanins without precipitating.

FIG. 4 shows the change in the red color of the model solution that is characterized by the optical density OD 520, with or without Acacia catechu tannin (at 3 g/L), and with or without sulfurous anhydride SO₂, which has the characteristic of discoloring the anthocyanins when they are in their free forms, i.e., combined with catechinic tannins or epicatechinic tannins and derivatives thereof.

It is noted that without sulfurous anhydride, in a first step the addition of the tannins that are extracted from Acacia catechu makes possible an enhancement of the color, whereby the optical density passes from 0.9 to 1.69. This shows well that these tannins play an important role in the stabilization of the color of wines.

After the addition of SO₂, the solution that is not stabilized by the tannins sees its red color decrease greatly (38.9%). In contrast, the addition of the same quantity of SO₂ into the medium that is stabilized by the Acacia catechu tannins only involves a reduction by 8.3% of the red color.

FIG. 5 shows the stabilizing action of the Acacia catechu tannin over time on the model solution relative to heat. A control solution and a solution that contains Acacia catechu tannins at a concentration of 3 g/L were kept in a double boiler for 8 hours at 80° C., and the red hue of the color was measured by measuring the OD 520.

It is noted that the red color is more significant for the solution with the tannins and that it remains stable over time, contrary to the control solution where there is a significant loss of color over time. This also confirms the stabilizing action of the useful tannins according to the invention.

These various tests show that the useful tannins according to the invention and particularly the tannins that are extracted from Acacia catechu, leaves of Camelia sinensis and the bark of Pinus sylvestris or Pinus pinaster have enological properties that are equivalent to those of the grape tannin and even greater, and do not have their drawbacks with regard to the appearance of undesirable phenolated derivatives that are responsible for olfactory defects, because they contain few if any (less than 10 ppm) paracoumaric and/or ferulic acids, phenol acids that are present in a significant quantity in the grape tannins.

In addition, they are economically much more advantageous than the grape tannin.

According to the invention, these tannins can be used as an enological product, on a grape must, a must that is still in fermentation, or a wine so as to stabilize the coloring material.

So as to optimize the rapidity of stabilization of the coloring material, it is preferable to use tannins that comprise at least 30% (+)catechin units and/or its derivatives relative to the total of (+)catechin and (−)epicatechin units and derivatives thereof, such as tannins that are extracted from Acacia catechu or pine bark. They can also be used for enhancing the structure of a wine, for facilitating the clarification of a wine in synergy with a clarifier, for absorbing undesirable protein components of wine, for an antibacterial action, and/or for an antioxidant action in a wine.

Use is preferably made after dissolution in water so as to facilitate the good dispersion and homogenization of the product within the must, the must also in fermentation, or wine.

According to a preferred method, the dissolution is 1 part of tannins per 10 parts of water. Preferably, the product is used in its instantaneous form, specific treatment with water vapor, which facilitates its dissolution.

According to the invention, the preferred doses of tannins are between 10 and 120 g/hL.

More particularly, they are from 10 to 40 g/hL for musts or wines that have a good tannin/anthocyanin balance, adhering to the ratio of 1 molecule of anthocyanin per 4 molecules of tannins; and they are from 40 to 120 g/hL for the musts or wines that have a certain imbalance in their tannin/anthocyanin ratio, i.e., having less than 4 tannin molecules per one anthocyanin molecule for questions of maturity, origin or sanitary condition of the grape at sale.

1-12. (canceled)

13. An enological product comprising a phloroglucinol-type proanthocyanidic tannin that contains less than 10 ppm of paracoumaric acid-type or ferulic acid-type phenol acids.

14. The enological product according to claim 13, wherein the tannin comprises at least 30% (+)catechin units and/or derivatives thereof relative to the total of (+)catechin and (−)epicatechin units and derivatives thereof that constitute said tannin.

15. The enological product according to claim 13, wherein the tannin comprises at least 50% of (+)catechin units and/or its derivatives relative to the total of (+)catechin and (−) epicatechin units and their derivatives that constitute said tannin.

16. The enological product Use of a proanthocyanidic tannin according to claim 13, wherein the tannin is extracted from Acacia catechu.

17. The enological product according to claim 13, wherein the tannin is extracted from pine bark.

18. The enological product according to claim 17, wherein the tannin is extracted from the bark of Pinus sylvestris or Pinus pinaster.

19. The enological product according to claim 13, wherein the tannin is extracted from Camelia sinensis leaves.

20. The enological product according to claim 13, wherein the tannin is incorporated in a must, a must still in fermentation, or a wine at a rate of 10 to 120 g/hl.

21. A method for stabilizing the color of a must, a must still in fermentation, or a wine, comprising adding the enological product according to claim 13 to the must, the must still in fermentation, or the wine.

22. A method of enhancing the structure of a wine, comprising adding the enological product according to claim 13 to the wine.

23. A method of clarifying a wine comprising adding the enological product according to claim 13 to the wine to facilitate the clarification of the wine in synergy with a clarifier and/or to absorb undesirable protein components of the wine.

24. A method of providing an antibacterial and/or antioxidant action in a wine comprising adding the enological product according to claim 13 to the wine
